(19) United States
(12) Patent Application Publication
(10) Pub. No.: US 2024/0028982 A1
(43) Pub. Date: Jan. 25, 2024

(54) PLAN MAKING DEVICE AND PLAN MAKING METHOD

(71) Applicant: Hitachi, Ltd., Tokyo (JP)

(72) Inventors: Yoshiyasu TAKAHASHI, Tokyo (JP); Yuichi KOBAYASHI, Tokyo (JP); Keitaro UEHARA, Tokyo (JP); Tsukasa EIRAKU, Tokyo (JP)

(21) Appl. No.: 18/117,561

(22) Filed: Mar. 6, 2023

(30) Foreign Application Priority Data
Jul. 20, 2022 (JP) 2022-115429

(51) Int. Cl. G06Q 10/0631; G06Q 50/04

(52) U.S. Cl. CPC G06Q 10/0631; G06Q 50/04

(57) ABSTRACT

Allowable constraint relaxation is achieved even when it is difficult to identify a constraint satisfaction solution. A production plan making device 1 that makes a plan related to a task has a production history DB2 that stores history information in the task, a past history reading unit 13 that reads the history information, a constraint relaxation unit 12 that identifies a deviation degree indicating a position relationship related to the constraint boundary of a constraint in making the plan of a history represented by the history information, calculates a weight indicating the degree of the constraint for constraint relaxation according to the deviation degree, and relaxes the weight when the plan cannot be made by an optimization process based on the weight, and a mathematical optimization unit 11 that makes the plan by the optimization process on the basis of the relaxed weight.

### CLAIM OF PRIORITY

The present application claims priority from Japanese Patent Application JP 2022-115429 filed on Jul. 20, 2022, the content of which are hereby incorporated by references into this application.

### BACKGROUND OF THE INVENTION

The present invention relates to a technique for assisting plan making in a task.

Plan making suitable for a production plan, a manpower plan, and the like in the industrial field is necessary in order to efficiently perform a task. For example, plan optimization is performed by using a mathematical optimization technique.

When the plan making including such the plan optimization is performed, a constraint related to the plan is considered. For example, it is necessary to identify a constraint satisfaction solution. However, there is a case where the constraint satisfaction solution cannot be found even after the elapse of a long time. In this case, performing constraint relaxation for relaxing the constraint related to the plan is an idea.

Here, Japanese Unexamined Patent Application Publication No. 2018-120342 proposes the following configuration in order to “make a suitable production plan in response to the actual state of a site”. Japanese Unexamined Patent Application Publication No. 2018-120342 describes that “a production plan making device stores information related to a production plan made in the past, generates, on the basis of the information, learning results that are results obtained by learning a relaxation priority that is a priority in which each of a plurality of constraints is to be relaxed and information used for predicting at least any one of the relationship of a constraint variable with an upper/lower limit set value when the constraint is relaxed, a leveling rate when the constraint is relaxed, and the relationship between the constraint variables when the constraint is relaxed, generates, on the basis of the learning results, a prediction result that is a result obtained by predicting at least any one of the relationship of the constraint variable with the upper/lower limit set value, the leveling rate, and the relationship between the constraint variables when each of the plurality of constraints is applied, and relaxes each of the constraints on the basis of the prediction result in the order of the relaxation priority, thereby making a production plan that can satisfy all of the plurality of constraints.

### SUMMARY OF THE INVENTION

Here, in Japanese Unexamined Patent Application Publication No. 2018-120342, the relaxation priority is previously given as the constant by manpower and the like, and the constraint is excluded in the order of the relaxation priority to determine whether or not the constraint can be satisfied. In this way, in Japanese Unexamined Patent Application Publication No. 2018-120342, since only whether the constraint is excluded or not is determined, when all of one constraint is attempted to be excluded, the accuracy of the plan making can be lowered depending on the selection thereof.

Accordingly, an object of the present invention is to achieve allowable constraint relaxation even when it is difficult to identify a constraint satisfaction solution.

To solve the above problem, in the present invention, constraint relaxation according to the deviation degree of a constraint in the history of plan making is performed. In addition, in this case, it is desirable to identify the weight of the constraint according to the deviation degree. A more specific configuration of the present invention is a plan making device that makes a plan related to a task. The plan making device has a storage device that stores history information in the task, and a processor that is connected to the storage device, reads the history information according to a program, identifies a deviation degree indicating a position relationship related to the constraint boundary of a constraint in making the plan of a history represented by the history information, calculates a weight indicating the degree of the constraint for constraint relaxation according to the deviation degree, relaxes the weight when the plan cannot be made by an optimization process based on the weight, and makes the plan by the optimization process on the basis of the relaxed weight. In addition, the present invention also includes a plan making method by using the plan making device, a program that causes the plan making device to function as a computer, and a recording medium that stores the program.

According to the present invention, the plan making corresponding to the allowable constraint relaxation is enabled even when it is difficult to identify the constraint satisfaction solution.

### BRIEF DESCRIPTION OF THE DRAWINGS

FIG. 1 is a functional block diagram of a production management system according to a first example;

FIG. 2 is a hardware configuration diagram of a production plan making device according to the first example;

FIG. 3 is a flowchart illustrating a process flow according to the first example;

FIG. 4 is a diagram illustrating order-product information used in the first example;

FIG. 5 is a diagram illustrating order-workload information used in the first example;

FIG. 6 is a diagram illustrating workload-product information used in the first example;

FIG. 7 is a diagram illustrating history-delivery date information used in the first example;

FIG. 8 is a flowchart illustrating a constraint relaxation process flow according to the first example;

FIG. 9 is a diagram illustrating display contents representing the relationship of each product with delivery date allowance according to the first example;

FIG. 10 is a diagram illustrating relaxed delivery date information included in a production plan according to the first example;

FIG. 11 is a diagram illustrating worker group prediction information included in the production plan according to the first example;

FIG. 12 is a diagram illustrating worker prediction information included in the production plan according to the first example;

FIG. 13 is a diagram illustrating display contents representing the relationship of each product with delivery date allowance according to a second example; and

FIG. 14 is a hardware configuration diagram of a production plan making system according to a third example.

### DETAILED DESCRIPTION OF THE PREFERRED EMBODIMENTS

An embodiment of the present invention will be described below. In this embodiment, plan optimization for a production plan, a manpower plan, and the like is targeted. And, this embodiment proposes a technique for identifying an allowable solution in the plan optimization even when it is difficult to find a constraint satisfaction solution since a constraint is strict. That is, in this embodiment, the constraint is relaxed to identify the constraint satisfaction solution that satisfies this. In this case, it is desirable to execute the constraint relaxation allowed by a person in charge for the plan. More specifically, the constraint relaxation according to the deviation degree of history information related to a task is performed. More desirably, as the history information has the smaller deviation degree, the weight of the constraint is increased. That is, as the history information has the smaller deviation degree, its constraint is given more importance, i.e., is evaluated more highly. As described above, in this embodiment, a plan making device related to the task, such as production, is targeted, and in the following respective examples, a production plan making device will be described as the case of the plan making device.

In addition, the deviation degree according to this embodiment is an index indicating a position relationship related to the constraint boundary of a history including farness and nearness and sparseness and denseness. Here, when the farness and nearness are used as the deviation degree, as the history is closer to the constraint boundary, the deviation degree is smaller. In addition, when the sparseness and denseness are used as the deviation degree, as the position relationship between a plurality of histories is denser, the deviation degree is smaller. Further, in this embodiment, the combination of the farness and nearness and the sparseness and denseness may be used as the deviation degree.

It should be noted that the deviation degree should indicate the relationship between the constraint boundary and the history in making the plan, and also includes other than the farness and nearness and the sparseness and denseness. And, in this embodiment, the weight of the constraint and a target function value are decided, and the constraint is relaxed by being responded to the decided weight of the constraint. And, the optimization can be made by using the target function value. Examples illustrating specific contents of this embodiment will be described below.

### Example 1

### (Overall Configuration)

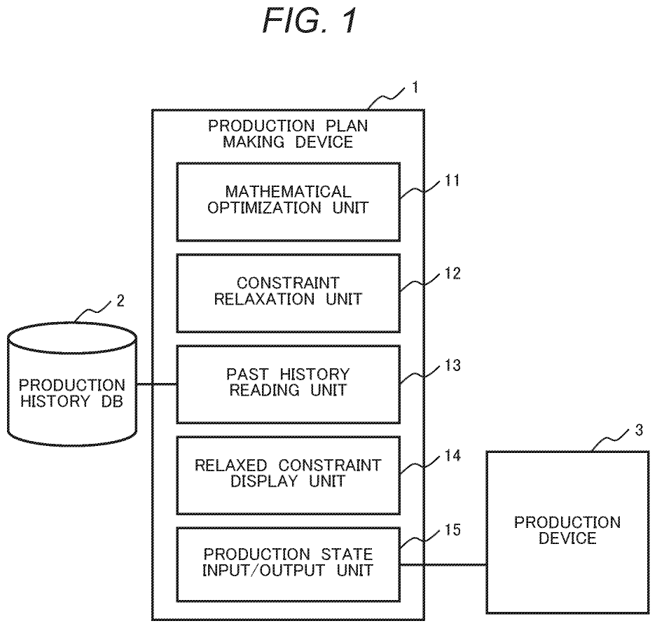

FIG. 1 is a functional block diagram of a production management system according to a first example. The production management system has a production plan making device 1, a production history DB 2, and a production device 3. The production plan making device 1 is a device for making a production plan in the production device 3. And, the production plan making device 1 has a mathematical optimization unit 11, a constraint relaxation unit 12, a past history reading unit 13, a relaxed constraint display unit 14, and a production state input/output unit 15.

Here, the mathematical optimization unit 11 makes the production plan. For this, the mathematical optimization unit 11 executes an optimization process. And, the optimization process uses the weight indicating the degree of the constraint (the weight of the constraint) and the target function value, which are identified by the constraint relaxation unit 12 described later. It should be noted that the mathematical optimization unit 11 desirably uses, as the weight, the constraint relaxed from the predetermined constraint. In addition, the optimization process should use at least the weight of the constraint identified by the constraint relaxation unit 12.

In addition, the constraint relaxation unit 12 performs the constraint relaxation in the optimization process according to the deviation degree between the constraint boundary and the history corresponding to this. Specifically, the constraint relaxation unit 12 identifies the relaxed weight of the constraint and the target function. Here, the deviation degree is an index indicating the association properties between the constraint boundary and the history corresponding to this, and includes the farness and nearness and the sparseness and denseness.

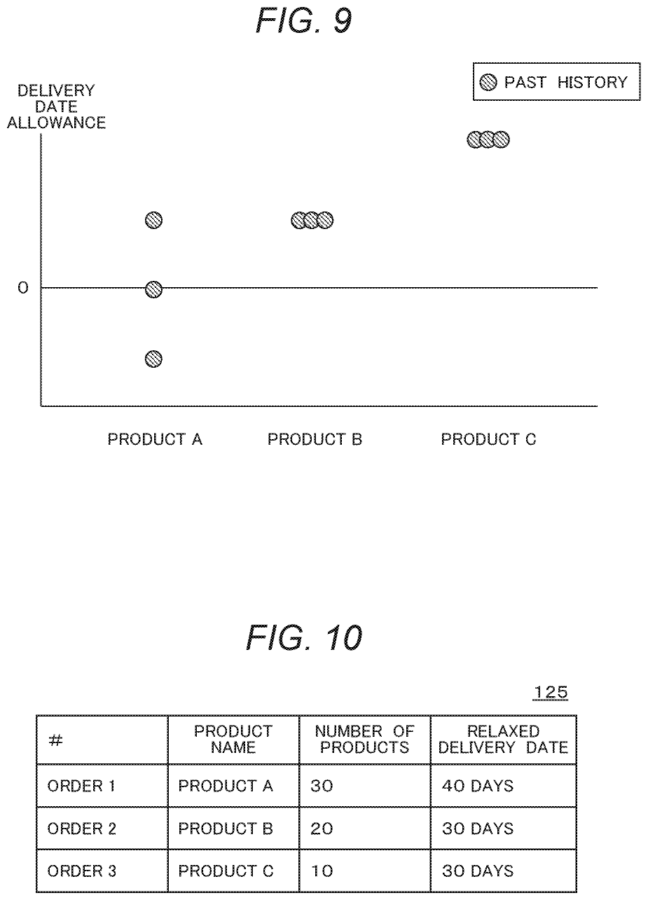

In addition, the past history reading unit 13 reads information and data used in the process of this example, such as the above history, from the production history DB 2. The read history is used by the constraint relaxation unit 12. In addition, the relaxed constraint display unit 14 displays the relationship between the constraint boundary and the history corresponding to this. The display contents thereof will be described later with reference to FIG. 9, but depending on the display contents, the deviation degree can also be grasped through intuition.

Further, the production state input/output unit 15 is connected to the production device 3, and transmits and receives information related to the production state. The production state input/output unit 15 outputs, as the information related to the production state, the production plan made by the mathematical optimization unit 11, to the production device 3, and receives, as an input, the production state from the production device 3.

In addition, the production history DB 2 is a type of storage device, and stores the history related to the production in the production device 3 and the like. These will be described later. In addition, the production device 3 executes the production of a product and the like according to the production plan made by the production plan making device 1.

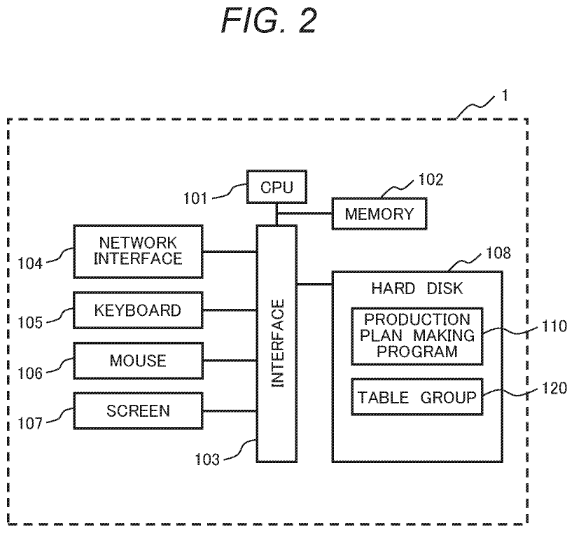

Next, the mounting example of the production plan making device 1 according to the first example will be described. FIG. 2 is a hardware configuration diagram of the production plan making device 1 according to the first example. In FIG. 2, the production plan making device 1 can be achieved by a computer. For this, as illustrated in FIG. 2, the production plan making device 1 has a CPU 101 (Central Processing Unit), a memory 102, a network interface 104, a keyboard 105, a mouse 106, a screen 107, and a hard disk 108, and these are connected to each other via an interface 103. Further, the interface 103 is desirably connected to the production history DB 2 (storage device). However, when the production history DB 2 is configured of an external file server, it is connected to the network interface 104.

First, the CPU 101 is an example of a so-called processor, and executes the process according to a production plan making program 110 stored in the hard disk 108. The process includes the process in the mathematical optimization unit 11, the constraint relaxation unit 12, and the past history reading unit 13 in FIG. 1. In addition, the memory 102 develops information included in the production plan making program 110 and a table group 120 used in the process in the CPU 101.

In addition, the interface 103 connects the respective components of the production plan making device 1, and can be achieved by a bus. In addition, the network interface 104 can execute the connection with the network, and execute the function of the production state input/output unit 15 of FIG. 1.

In addition, the keyboard 105 and the mouse 106 are input devices receiving the operation from the user. It should be noted that the keyboard 105 and the mouse 106 are an example of the input device, and at least one of these may be used, and other input devices may be used. Further, the input device may be omitted.

In addition, the screen 107 is a display screen displaying the process result in the CPU 101, the input by the input device, and the like. For this, the screen 107 can execute the function of the relaxed constraint display unit 14 of FIG. 1. It should be noted that the screen 107 may be omitted, the above contents may be displayed on a different device, and a configuration outputting by printing and voice may be provided. That is, the production plan making device 1 can be provided with some output device that outputs various information described later.

Further, the hard disk 108 stores the production plan making program 110 and the table group 120. The hard disk 108 may be achieved by various recording media, such as an external HDD (Hard Disk Drive), an SSD (Solid State Drive), and a memory card. Further, like the file server, the hard disk 108 may be achieved by a device different from the production plan making device 1. That is, the production history DB 2 of FIG. 1 can correspond to the hard disk 108. That is the end of the description of the configuration of the first example.

### (Process Flow and Information)

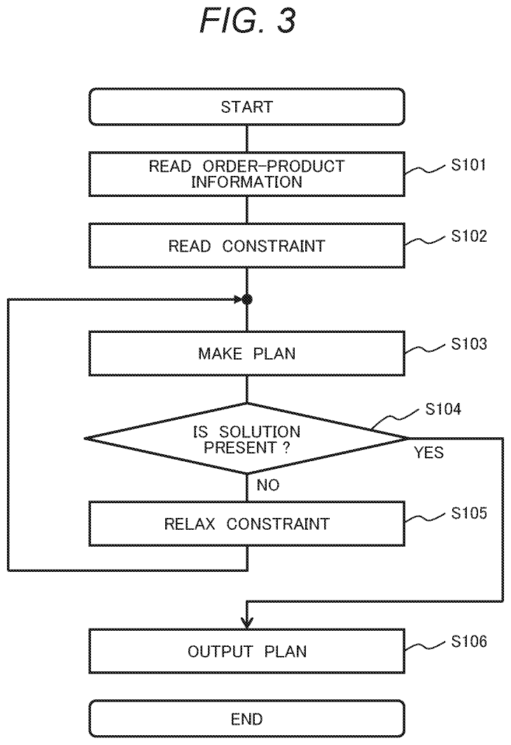

Next, the process flow of the first example and information used in the process flow will be described. FIG. 3 is a flowchart illustrating the process flow according to the first example. The contents thereof will be described below with reference to the configuration illustrated in FIG. 1.

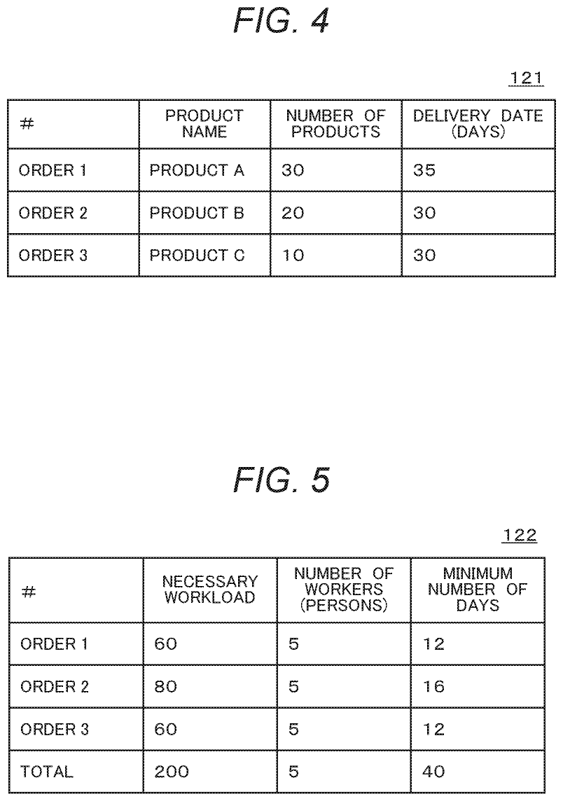

First, in step S101, the past history reading unit 13 reads, from the production history DB 2, order-product information 121 of the product targeted by the production plan to be made. The step may be executed according to the instruction from the user, and may be automatically executed when the predetermined condition is satisfied. Here, FIG. 4 is a diagram illustrating the order-product information 121 used in the first example. The order-product information 121 is information related to the delivery of the product to be produced for each order. More specifically, the order-product information 121 has the respective items of the product name, the number of products, and the delivery date for each order.

In addition, in step S102, the past history reading unit 13 reads, from the production history DB 2, the constraint in the production plan corresponding to the order-product information 121 read in step S101. In this example, order-workload information 122 and workload-product information 123 are read as the constraint. That is, the order-workload information 122 and the workload-product information 123 corresponding to the product and the workload of the order-product information 121 are read. Here, FIG. 5 is a diagram illustrating the order-workload information 122 used in the first example. The order-workload information 122 is information related to the work process of the product to be produced for each order. More specifically, the order-workload information 122 has the respective items of the necessary workload, the number of workers, and the minimum number of days for each order. Here, the minimum number of days indicates the number of days required for achieving the corresponding necessary workload by the number of workers. In this way, the constraint according to the first example indicates the necessary workload in the production of the product.

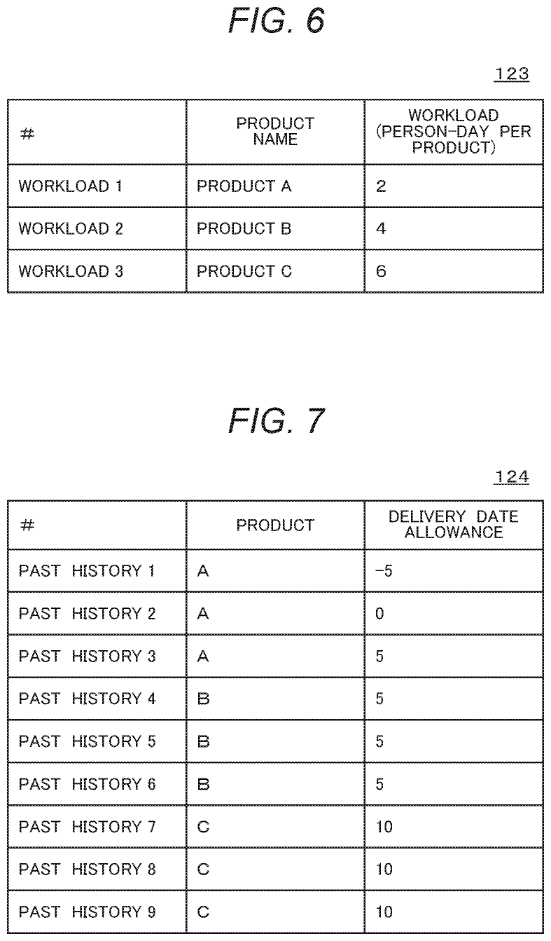

In addition, FIG. 6 is a diagram illustrating the workload-product information 123 used in the first example. The workload-product information 123 is information for managing the work process (the workload). More specifically, the workload-product information 123 has the respective items of the product name and the workload therefor for each identification information (#) of the work process. The workload here indicates the number of days required by one worker for producing one product.

In addition, in step S103, the mathematical optimization unit 11 executes the optimization process by using the target function according to the read constraint, and makes the production plan with respect to the order-product information 121. And, in step S104, the mathematical optimization unit 11 determines whether the solution of the optimization process, i.e., the production plan, satisfying the read constraint is present. As a result, when the solution is present (YES), the process changes to step S106. In addition, when the solution is absent (NO), the process changes to step S105.

In addition, in step S105, the constraint relaxation unit 12 relaxes the constraint read in step S102 by using the history related to the making of the production plan. Here, in the first example, the past history reading unit 13 reads, as the history related to the making of the production plan, history-delivery date information 124. FIG. 7 is a diagram illustrating the history-delivery date information 124 used in the first example. As illustrated in FIG. 7, the history-delivery date information 124 is information indicating the actual example (history) of the product and the delivery date allowance thereof. Here, the delivery date allowance is indicated by the different number of days from the required or scheduled delivery date. For example, the past history 1 indicates that the product A is delivered 5 days later than the delivery date, and the past history 2 indicates that the product A is delivered on the delivery date. Further, the past history 3 indicates that the product A is delivered 5 days earlier than the delivery date, i.e., is delivered with allowance according to that.

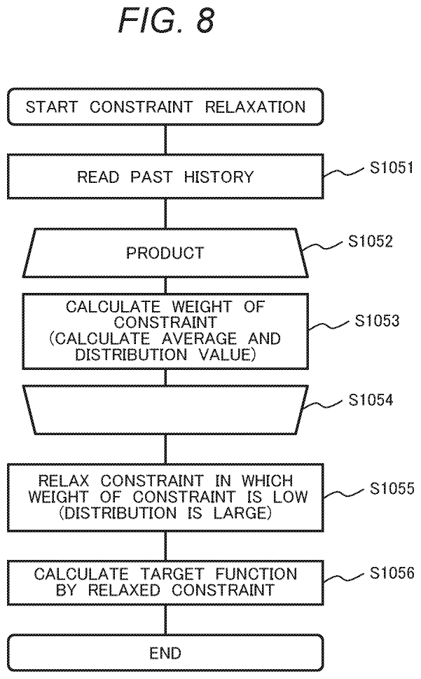

An example of the constraint relaxation process in step S105 using the history-delivery date information 124 will be described below. FIG. 8 is a flowchart illustrating the constraint relaxation process flow according to the first example. In step S1051, the constraint relaxation unit 12 reads the past history, i.e., the history-delivery date information 124.

In addition, steps S1052 to S1054 are repeated for each product targeted by the production plan. First, in step S1052, the constraint relaxation unit 12 extracts the history related to the making of the production plan from the read history-delivery date information 124. That is, the past history of the product targeted by the production plan is extracted. Here, when the production plan for the order 1 of FIG. 4 is made, the past histories 1 to 3 including the product A of FIG. 7 are extracted.

In addition, in step S1053, the constraint relaxation unit 12 calculates the weight of the constraint for the extracted past history. For this, in this example, first, the constraint relaxation unit 12 calculates a standard deviation as an example of an average value and a distribution value by using (Mathematical 1) and (Mathematical 2).

$$\begin{matrix}( Mathematical 1 ) & \\ average {μ}_{i} = \frac{{Σ}_{k} {X}_{i , k}}{{N}_{i}} & ( Mathematical 1 )\end{matrix}$$

$$\begin{matrix}( Mathematical 2 ) & \\ standard deviation {σ}_{i} = \sqrt{\frac{{{Σ}_{k} ( {X}_{i , k} - {μ}_{i} )}^{2}}{{N}_{i}}} & ( Mathematical 2 )\end{matrix}$$

Here, in (Mathematical 1) and (Mathematical 2), X indicates the “delivery date allowance”, and N indicates the number of extracted past histories. As a result, the constraint relaxation unit 12 calculates the average value by (Mathematical 1), and applies this result to (Mathematical 2), thereby calculating the standard deviation. Here, the standard deviation indicates the deviation between the constraint boundary and the history. For this, the standard deviation can be used as an example of the deviation degree.

In addition, the standard deviation may be used as the deviation degree based on the distance between the past history and the constraint boundary. For this, the constraint relaxation unit 12 calculates the distance from the constraint boundary for each read past history. And, the constraint relaxation unit 12 defines the inverse number of the calculated distance as the weight of the history. In addition, the constraint relaxation unit 12 distributes the constraint boundary according to the weight, and defines, as the weight, the weight of the distributed constraint section.

Next, in step S1054, the constraint relaxation unit 12 determines whether the calculation of the weight with respect to the product targeted by the production plan has been ended, and when the calculation has not been ended, the constraint relaxation unit 12 executes the process after S1052 for the remaining products. In addition, when the calculation has been ended, the process changes to step S1055.

In addition, in step S1055, the constraint relaxation unit 12 relaxes the weight calculated in step S1053. Here, in this example, to relax the weight, the standard deviation that is an example of the deviation degree is used. And, the constraint relaxation unit 12 determines, by using (Mathematical 3), whether the unrelaxed constraint (weight) is the predetermined threshold value (ci) or less. Here, the constraint (weight) being the predetermined threshold value (ci) or less, i.e., being small, means that the standard deviation is large. This also means that the deviation degree is the predetermined value or more. It should be noted that the threshold value (ci) may be previously stored by the production plan making device 1, and may receive the production plan making device 1 from the user.

(Mathematical 3)

Original constraint (weight) fᵢ(x)≤cᵢ (Mathematical 3)

It should be noted that when the deviation degree based on the distance between the past history and the constraint boundary is used, the constraint relaxation unit 12 performs the relaxation by using a straight line connecting the constraint boundary and the past history.

And, when the unrelaxed constraint (weight) is the predetermined threshold value (ci) or less, the constraint relaxation unit 12 relaxes the weight of the constraint by using (Mathematical 4) according to the standard deviation that is an example of the deviation degree, i.e., calculates the relaxed constraint (weight).

(Mathematical 4)

Relaxed constraint (weight) fᵢ*(x)≤cᵢ+μᵢ+αᵢ·σᵢ (Mathematical 4)

In addition, in step S1056, the constraint relaxation unit 12 calculates the target function by applying the calculated relaxed constraint (weight) to (Mathematical 5).

(Mathematical 5)

Target function (minimization) g(x)=#{X_{i,k}|X_{i,k}>cᵢ+μᵢ+αᵢ·σᵢ} (Mathematical 5)

That is the end of the description of the flowchart of FIG. 8, i.e., the constraint relaxation process (step S105), and the description of FIG. 3 will be returned. When the constraint is relaxed in step S105, the process changes to step S103. In step S103, the mathematical optimization unit 11 executes the optimization process by using the target function according to the relaxed constraint, i.e., the target function calculated in step S1056, and makes the production plan. As a result, the production plan in which the delivery date is extended is made for the product that cannot be produced for the initial delivery date schedule or has the difficulty of being produced for the initial delivery date schedule. And, in step S104, step S105 is repeated until the solution of the optimization process satisfying the relaxed constraint is present.

And, when the solution of the optimization process satisfying the relaxed constraint is present, the relaxed constraint display unit 14 displays the made production plan in step S106. It should be noted that in this case, in addition to the production plan, the relationship of each product with the delivery date allowance may be displayed. The contents of this display will be described. FIG. 9 is a diagram illustrating the display contents representing the relationship of each product with the delivery date allowance according to the first example. In FIG. 9, the delivery date allowance that is the past history related to the delivery date allowance is plotted and displayed for each product. In the first example, the delivery date=0 (no delivery date allowance) is the constraint boundary. By performing the display of FIG. 9, the deviation degree related to the delivery date allowance can be grasped through intuition. In the example of FIG. 9, the product C is the furthest from the constraint boundary in terms of the distance from the constraint boundary. That is, when the distance is used, the deviation degree of the product C is maximum. In addition, in the example of FIG. 9, the average of the past histories (delivery date allowance) of the product A is 0, and the distance from the constraint boundary is minimum, but the distribution of each past history is maximum. In this case, one of the distance and the distribution may be used as the deviation degree, and the deviation degree in which both of the distance and the distribution are taken into consideration may be used by the predetermined rule and mathematical equation.

In addition, FIGS. 10 to 12 are information representing the contents of the production plan made in the first example. FIG. 10 is a diagram illustrating relaxed delivery date information 125 included in the production plan according to the first example. The relaxed delivery date information 125 has the same configuration as the order-product information 121 illustrated in FIG. 4, but indicates the relaxed delivery date. In this way, since the relaxed delivery date information 125 has the same structure as the order-product information 121, one of them may be provided and the delivery date may be updated, as needed.

In addition, FIG. 11 is a diagram illustrating worker group schedule information 126 included in the production plan according to the first example. The worker group schedule information 126 is information indicating the schedule for producing the product for each group of a plurality workers (workers 1 to 5). FIG. 11 illustrates that the workers 1 to 5 produce the product B, the product C, and the product A in that order.

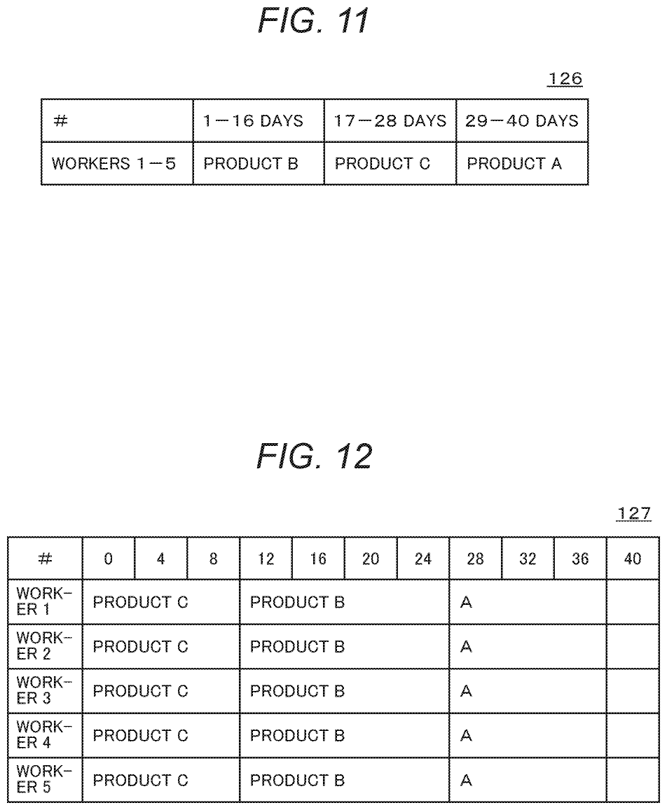

In addition, FIG. 12 is a diagram illustrating worker schedule information 127 included in the production plan according to the first example. The worker schedule information 127 is information indicating the schedule for producing the product for each worker. FIG. 12 illustrates that each worker produces the product B, the product C, and the product A in that order. It should be noted that at least one of the worker group schedule information 126 and the worker schedule information 127 should be provided. That is the end of the description of the first example, but in the first example, the suitable constraint relaxation according to the deviation degree can be achieved.

### Example 2

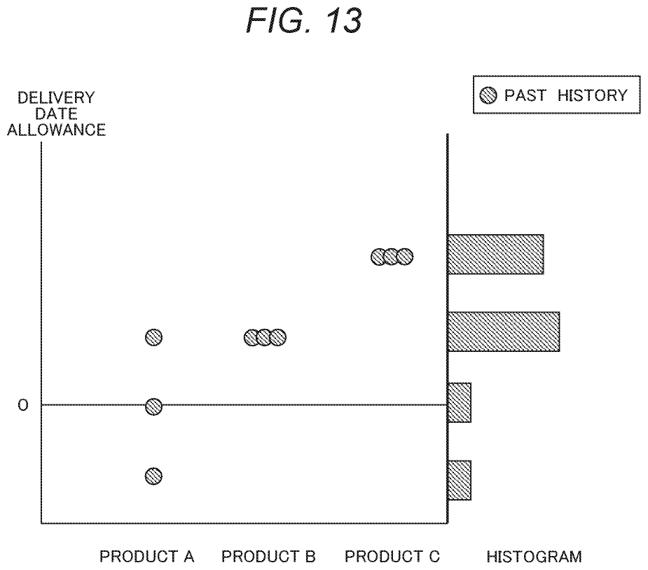

In a second example, display different from the first example is performed. FIG. 13 is a diagram illustrating display contents representing the relationship of each product with the delivery date allowance according to the second example. In FIG. 13, in addition to the display contents of the first example, a histogram is displayed. The histogram is information representing the total number of past histories of each product for each delivery date allowance. FIG. 13 illustrates that the number of past histories of plus (with allowance) is larger than the delivery date of 0 or minus (without allowance). In this way, according to the second example, the state of the past history can be grasped through intuition.

### Example 3

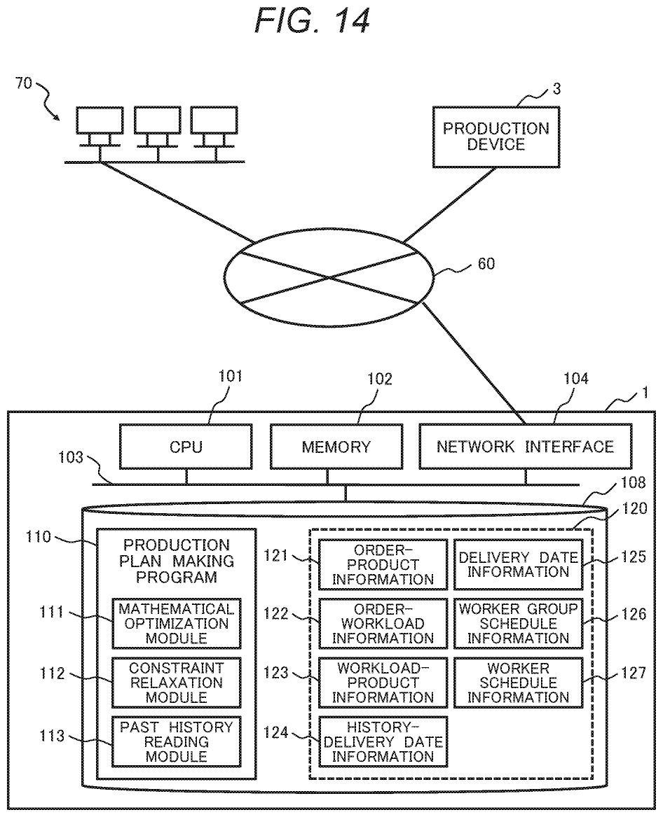

A third example illustrates an example in which the production plan making device 1 is achieved by a server, such as the cloud. FIG. 14 is a hardware configuration diagram of a production plan making system according to the third example. In the third example, the production plan making device 1 is connected to the production device 3 and a management terminal group 70 via a network 60. In addition, the management terminal group 70 can be achieved by a computer, such as a so-called PC and tablet. And, the management terminal group 70 receives the operation from the user, and notifies this to the production plan making device 1. As a result, the production plan making device 1 executes the process according to the operation. In addition, the management terminal group 70 receives the process result of the production plan making device 1, and outputs this. For example, the display contents of the first and second examples, the made production plan, and the like are outputted. It should be noted that the user using the management terminal group 70 includes a person in charge executing the production management.

In addition, the production plan making device 1 of the third example is achieved by the server, but has, as the computer, hardware similar to the first example. That is, the production plan making device 1 of the third example has the CPU 101, the memory 102, the network interface 104, and the hard disk 108, and these are connected to each other via the interface 103. However, since the management terminal group 70 has the functions of the keyboard 105, the mouse 106, and the screen 107 of the first example, they can be omitted in this example. Also, the hard disk 108 corresponds to the production history DB 2 of FIG. 1, but like the first example, this can be externally provided.

And, the production plan making program 110 and the table group 120 are stored in the recording medium represented by the hard disk 108. These are similar to those described in the first example, but the contents thereof will be briefly described below.

First, the production plan making program 110 has a mathematical optimization module 111, a constraint relaxation module 112, and a past history reading module 113. These respective modules execute the same processes as the respective units of FIG. 1. That is, the mathematical optimization module 111 corresponds to the mathematical optimization unit 11, the constraint relaxation module 112 corresponds to the constraint relaxation unit 12, and the past history reading module 113 corresponds to the past history reading unit 13. In addition, the respective information structuring the table group 120 has been described in FIGS. 4 to 7 and FIGS. 10 to 12.

It should be noted that in the third example, the production plan with respect to a plurality of production devices may be made by the production plan making device 1. Further, the production plan making device 1 may be achieved as a production management device executing the production management.

In the third example described above, since the production plan making device 1 can be achieved as the server, the operation cost of the production device 3 can be reduced.

The above respective examples are the illustration of the present invention, and the present invention includes various modification examples and application examples.

For example, at least one of the distance and the distribution may be used as the deviation degree, and other parameters may be used. Further, the present invention is applicable to other than the making of the production plan. For example, the present invention is also applicable to the making (including correction) of a maintenance plan with respect to equipment and a facility and the making of the operation plan for the facility and the like.

### REFERENCE SIGNS LIST

1 . . . production plan making device, 11 . . . mathematical optimization unit, 12 . . . constraint relaxation unit, 13 . . . past history reading unit, 14 . . . relaxed constraint display unit, 15 . . . production state input/output unit, 101 . . . CPU, 102 . . . memory, 103 . . . interface, 104 . . . network interface, 105 . . . keyboard, 106 . . . mouse, 107 . . . screen, 108 . . . hard disk, 110 . . . production plan making program, 111 . . . mathematical optimization module, 112 . . . constraint relaxation module, 113 . . . past history reading module, 120 . . . table group 121 . . . order-product information, 122 . . . order-workload information, 123 . . . workload-product information, 124 . . . history-delivery date information, 125 . . . relaxed delivery date information, 126 . . . worker group schedule information, 127 . . . worker schedule information, 2 . . . production history DB, 3 . . . production device

What is claimed is:

1. A plan making device that makes a plan related to a task, comprising:
a storage device that stores history information in the task; and
a processor that is connected to the storage device, reads the history information according to a program, identifies a deviation degree indicating a position relationship related to the constraint boundary of a constraint in making the plan of a history represented by the history information, calculates a weight indicating the degree of the constraint for constraint relaxation according to the deviation degree, relaxes the weight when the plan cannot be made by an optimization process based on the weight, and makes the plan by the optimization process on the basis of the relaxed weight.

2. The plan making device according to claim 1, wherein the deviation degree is at least either farness and nearness of the history and the constraint boundary or sparseness and denseness of the history.

3. The plan making device according to claim 2, wherein the constraint is a necessary workload in the production of each product, and
wherein the processor makes, on the basis of the relaxed weight, the production plan of the product in which the delivery date of the product is extended.

4. The plan making device according to claim 3, wherein the processor uses, as the constraint, order-workload information related to the work process of the product and workload-product information for managing the work process of the product.

5. The plan making device according to claim 3, wherein the plan making device further has an output device that outputs the relationship of the each product with delivery date allowance.

6. The plan making device according to claim 5, wherein the output device further outputs a histogram that represents the total number of past histories of the product.

7. A plan making method that uses a plan making device that makes a plan related to a task by a computer,
wherein a storage device stores history information in the task, and
wherein a processor that is connected to the storage device reads the history information according to a program, identifies a deviation degree indicating a position relationship related to the constraint boundary of a constraint in making the plan of a history represented by the history information, calculates a weight indicating the degree of the constraint for constraint relaxation according to the deviation degree, relaxes the weight when the plan cannot be made by an optimization process based on the weight, and makes the plan by the optimization process on the basis of the relaxed weight.

8. The plan making method according to claim 7, wherein the deviation degree is at least either farness and nearness of the history and the constraint boundary or sparseness and denseness of the history.

9. The plan making method according to claim 8,
wherein the constraint is a necessary workload in the production of each product, and
wherein the processor makes, on the basis of the relaxed weight, the production plan of the product in which the delivery date of the product is extended.

10. The plan making method according to claim 9, wherein the processor uses, as the constraint, order-workload information related to the work process of the product and workload-product information for managing the work process of the product.

11. The plan making method according to claim 9, wherein an output device further has an output device that outputs the relationship of the each product with delivery date allowance.

12. The plan making method according to claim 11, wherein the output device further outputs a histogram that represents the total number of past histories of the product.
